(19) United States
(12) Patent Application Publication
(10) Pub. No.: US 2001/0027952 A1
(43) Pub. Date: Oct. 11, 2001

(54) Process and product for removing hydrocarbons

(76) Inventors: Ricardo Horacio Ciancaglini, De Buenos Aires (AR); Luis Oscar Chiesa, De Buenos Aires (AR); Francisco Antonio Mazzeo, De Buenos Aires (AR)

Correspondence Address: OSTROLENK FABER GERB & SOFFEN, 1180 AVENUE OF THE AMERICAS, NEW YORK, NY, 100368403

(21) Appl. No.: 09/795,641

(22) Filed: Feb. 28, 2001

(30) Foreign Application Priority Data
Feb. 29, 2000 (AR) P 00 01 00890

(51) Int. Cl. B01D 15/00

(52) U.S. Cl. 210/660; 210/263

(57) ABSTRACT

To collect spilled hydrocarbons, bird feathers are scattered over a surface having hydrocarbons at it or in water containing hydrocarbons. The feathers remain until they are saturated with the hydrocarbons and the feathers are thereafter collected. The feathers may be located inside a mesh which is laid on the surface where the hydrocarbons are.

### BACKGROUND OF THE INVENTION

The present invention relates to a process for removal and collection of hydrocarbons, to a product to be used in the process, a process for embodying the product and the use thereof in the process, and more precisely it relates to the removal and collection of oil spills occurring on either solid or liquid surfaces, or even those contained in liquid masses, for example due to accidents and/or sinking of tanker ships on rivers, seas and oceans, or spills on land from tanker trucks, etc.

Everyone is familiar with the disasters produced by oil spills caused by tankers, such as the oil tanker VALDEZ of EXXON Corporation. In March 1989, the VALDEZ ran aground on a sand bank in Alaska, spilling more than 232,000 barrels of crude oil. The effects of the incident are still not entirely known. However, it is known that only 25% of the migratory salmon returned to the area of the accident the following year, thousands of sea otters were poisoned and thousands of sea birds perished. This was only one of the hundreds of cases of oil spillage that occur on the high seas.

The most effective method for cleaning up the oil slicks from the ocean involves gathering the oil. This not only removes the oil from the sea, but it can also be recovered for use. The first step in gathering the oil is to surround the slick with a floating barrier. This can comprise an inflatable boom which has a membrane that retains the spilled oil. The membrane includes a chain in its base to keep it straight. On the other hand, the inflatable boom can be replaced with an absorbent material which acts like a sponge. That can be of a natural material, for example straw, or of a synthetic material, for example polypropylene.

An inflatable barrier is costly and may not withstand damage produced by rocks, or the like. In the event of tearing or breakage, the oil leaks through said tear or breakage. Moreover, when absorbent materials are used on absorbing the oil, these also absorb large quantities of water. It is possible for water to represent 90% of the liquid absorbed. Moreover, the absorbent materials are not suitable for absorbing large amounts of oil, and their use is restricted to small spills or pockets remaining from large spills.

Likewise, because one of the main problems in oil pollution is that oil slicks remain together and float on the surface of the water, chemical products, generally termed dispersants, have been developed. These can be spread on an oil slick to divide up a large slick into smaller ones, which are diluted into the water without causing greater harm. Nevertheless, because the way these chemical dispersants work, they cannot be employed on thick or viscous oils, which includes some crude oils and all heavy fuel oils. In addition, the majority of crude oils that are capable of being dispersed, change their properties after being in cold water for a few hours and then cannot be dispersed. For that reason, the application of the dispersant must be carried out straightaway by a helicopter, which is not always available in the vicinity of the spill.

Scientists have also developed a new type of dispersant which consists mainly of micro-organisms. This type of oil removal is called bioremediation. In it, the oil can be degraded biologically by a great variety of micro-organisms, including pseudomonas, various corinebacteria and micro-bacteria, and even some yeasts.

To eliminate oil spills, the micro-organisms work by oxidising the oil to CO₂. When large oil spills occur, their volatile hydrocarbon fractions quickly evaporate, leaving their long chain, aliphatic and aromatic components to be eliminated by the organisms.

The dispersants, however, contain contaminating components. For this reason, before they are used, consideration must be given to the depth of the water where the spill is located, the strength of the currents, and what type of sea life is present in the zone in question. Also, these dispersants are very expensive. For example, EXXON has spent more than 1.5 billion dollars in cleaning up the oil spilled from the VALDEZ using bioremedial processes.

In response to the VALDEZ incident, as a solution to apply to oil spills, the United States' oil pollution statute dictates that all new oil tankers are to be built with double hulls so that, in the event of the ship colliding with some object, only the outer hull is punctured, and spillage is avoided. As a further measure, in the event of spillage should the ship be punctured, the tank is fitted with hydrostatic controls, whereby the internal pressure of the tank is made the same as the external pressure, preventing the oil from running out. These measures are however very expensive to implement and, since their use is only voluntary, they have not been extensively taken up by shipbuilders.

### SUMMARY OF THE INVENTION

It is therefore an object of the present invention to provide a process for removing and collecting spilled hydrocarbons that does not pollute the environment when applied and that is economical.

It is a further object to provide a process for the removal and collection of spilled hydrocarbons that preferably only absorbs the hydrocarbons, without absorbing water or other components.

It is therefore an object of the present invention to provide a process for the removal and collection of hydrocarbons spilled on solid or liquid surfaces polluted with the hydrocarbons, wherein the procedure comprises the steps of: scattering bird feathers over the surface on which non-polar or low density substances are present, permitting the feathers to act until saturated with those substances and then gathering up the saturated feathers.

### BRIEF DESCRIPTION OF THE INVENTION

For greater clarity and understanding of the present invention, it has been illustrated in several Figures, in which the invention is shown in some of the preferred embodiments, all by way of example, wherein:

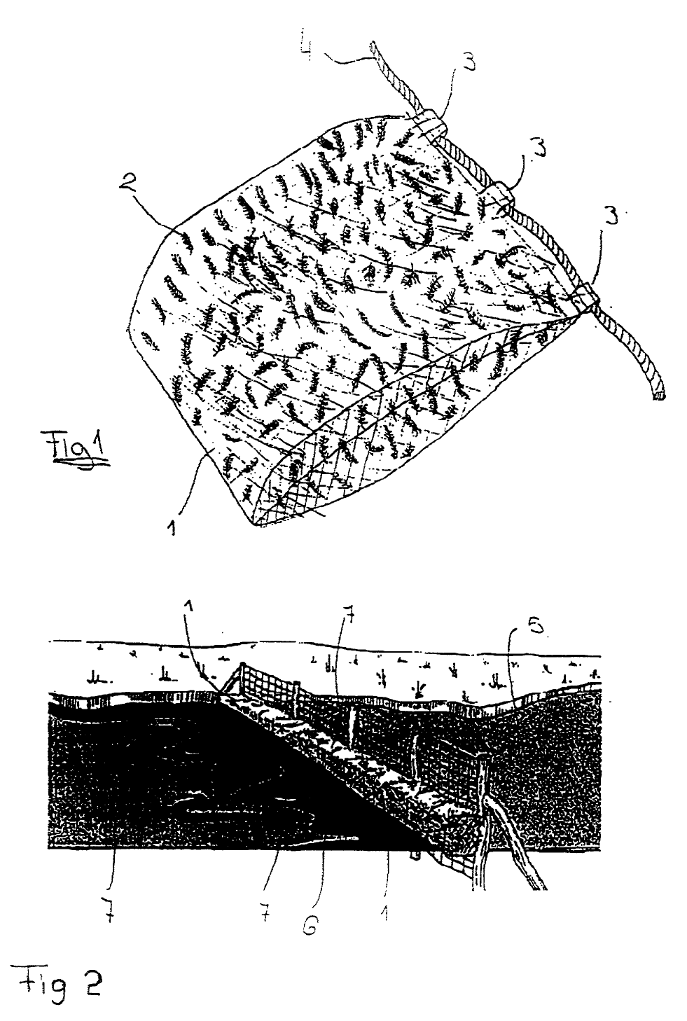

FIG. 1 is a top view, in perspective, which illustrates a product of the invention comprised of feathers within a mesh;

FIG. 2 is an illustration of an application of the product of the invention for the absorption of hydrocarbons according to the object of the present invention.

### DESCRIPTION OF A PREFERRED EMBODIMENT

With reference first to FIG. 1, a suitably woven mesh 1 holds a plurality of bird feathers 2. The mesh has various eyelets 3, though which a rope or chain 4 is passed, in order to be able to join adjacent meshes 1 and/or fasten the mesh to a boom 5, such as shown in FIG. 2, or to a boat for the transport and subsequent removal (not shown).

From FIG. 2, it is possible to appreciate how the feathers 2 held in the mesh 1 perform the function of absorbing an oil slick 6 spilled on water 7.

Once the feathers 2 are saturated with oil, the meshes 1 are withdrawn and if an oil slick remains, the old meshes are replaced with new meshes 1.

For a better understanding of why feathers 2 are used for the absorption of oil slicks 5, there follows a brief outline of the properties and characteristics of the feathers and how they are obtained.

Feathers are the most important features of bird skins. However, there is a large, clearly visible, cutaneous structure, called the uropygial gland, located on the rump at the base of the tail. It produces an oily secretion that is spread by the birds over their feathers with the beak when preening. This gland is particularly well developed in aquatic birds, and secretions therefrom are important in that it renders the feathers waterproof

The use of bird feathers for the absorption of spilled oil slicks is based on the absorption capacity of bird feathers for non-polar or low polarity substances, such as hydrocarbons. This property is known as oleophilia. The feathers develop a between 4 and 8% animal fat content, due to the uropygial gland described above that fat which has the oleophilic characteristic. The fat content is established after the conditioning treatment described below.

The feathers with this animal fat and subjected to various treatments, are capable of absorbing hydrocarbons in an amount up to between 4 and 5 times their own weight, this absorbent feature being favored in the feathers 2 thanks to their extensive contact area. Although the feather has an oleophilic nature, it is not entirely hydrophobic, and it is capable of absorbing up to 0.25 parts water for each part feather. This, when compared with the known methods of absorption, such as those already mentioned, is a highly appreciated feature.

The feathers 2 are obtained mainly from the aviculture industry where, up to this time, these feathers were considered to be waste with no other use. After being plucked from a bird, the feathers enter a rancidification process of the fatty part and putrification of the proteinic part. Before using the feathers for oil slick absorption, it is preferable to subject them to a conditioning treatment, which includes washing and drying. Optionally, the feathers can undergo a combing, or carding, process. This prior conditioning of the feathers 2 is termed biological stabilization and it permits the subsequent use of the feathers in an optimum state for the absorption of oil slicks. As a final step, after the removal of the spilled oil, it is possible to finally dispose of the oil in incinerating furnaces adapted to burn it, or the oil can be recycled in order to reuse the oil. The already saturated feathers can also be buried or encapsulated, in accordance with governmental regulations concerning ecology and waste disposal.

The feathers 2, in this preferred embodiment, are situated inside an open-woven mesh 1. This does not imply a limitation to the development or arrangement of the feathers. It is possible to arrange them in the form of blankets, cut and bound by a binding element which does not impair their absorbent property, or to simply scatter them from the air in large quantities to be later gathered up by oil slick collection machines, such as the ship AL WASSIT, which can skim more than 1.6 square kilometers per day.

Finally, from that described above, it can be deduced that the object of the present invention, not only improves the activity of removing slicks of spilled oil due to its low cost. In addition, by containing entirely natural products, there should be no restrictions with respect to areas of use, and no run risks of increasing the ecological impact caused by an oil spill.

Although the present invention has been described in relation to a particular embodiment thereof, many other variations and modifications and other uses will become apparent to those skilled in the art. It is preferred, therefore, that the present invention be limited to not by the specific disclosure herein, but only by the appended claims.

1. A process for removing and collecting hydrocarbons that are located on or contained in liquids or on solids, the process comprising the steps of
scattering bird feathers over a surface of the liquid or solid where the hydrocarbons are located;
leaving the feathers until they are saturated with substances including the hydrocarbons; and
then collecting the saturated feathers.

2. The process of claim 1, further comprising prior to scattering the feathers, the further step of collecting the bird feathers, washing the feathers and subsequently drying the feathers until the feathers have an animal fat content of between 4% and 8% by weight.

3. The process of claim 2, wherein after the washing and the drying, the feathers have an absorption capacity of the order of 4 to 5 times their weight.

4. The process of claim 2, further comprising carding the feathers after the washing and the drying thereof.

5. A process for removing and collecting hydrocarbons contained in a liquid comprising the steps of
positioning bird feathers in the liquid where the hydrocarbons are located;
leaving the feathers until they are saturated with substances including the hydrocarbons;
removing the saturated feathers from the liquid.

6. A process of claim 5, further comprising moving the feathers through the hydrocarbon containing liquid prior to saturation of the feathers.

7. The process of claim 1, further comprising collecting the feathers together to form a mesh before thereafter scattering the feathers by scattering the mesh over the surface or in the liquid where the hydrocarbons are located.

8. A product for removing and collecting hydrocarbons on or contained in a liquid or on a solid, comprising a collection of saturatable bird feathers for being disposed on the surface of the solid or the liquid or for being in the liquid, the feathers being adapted to be saturated with a substance including the hydrocarbons before the feathers are thereafter removed from the surface or from in the liquid.

9. The product of claim 8, wherein the bird feathers have a capacity to absorb hydrocarbons on the order of 4 to 5 times their weight.

10. The product of claim 8, wherein the feathers have an animal fat content of between 4% and 8% by weight.

11. The product of claim 8, wherein the bird feathers have been treated by means of biological stabilization.

12. The product of claim 11, wherein the treatment by biological stabilization comprises washing the feathers and then drying the feathers.

13. The product of claim 12, wherein the treatment further comprises then carding the feathers.

14. The product of claim 12, wherein the feathers have an animal fat content of between 4% and 8% by weight after the treatment.

15. The product of claim 8, wherein the bird feathers are arranged in layers for application on the surface or in the liquid.

16. The product of claim 15, wherein the layers are defined by a compacted mesh of the feathers.
